(19) United States
(12) Patent Application Publication
(10) Pub. No.: US 2024/0256851 A1
(43) Pub. Date: Aug. 1, 2024

(54) DEEP LEARNING-BASED MULTI-OBJECTIVE PACING SYSTEMS AND METHODS

(71) Applicant: Walmart Apollo, LLC, Bentonville, AR (US)

(72) Inventors: Yue Ding, Mountain View, CA (US); Changzheng Liu, Sunnyvale, CA (US); Jixiang Huang, Pleasanton, CA (US); Boning Zhang, Santa Clara, CA (US); Georgios Rovatsos, San Francisco, CA (US); Wei Shen, Pleasanton, CA (US); Dongbo Zhang, Redwood City, CA (US)

(21) Appl. No.: 18/104,098

(22) Filed: Jan. 31, 2023

(51) Int. Cl. G06N 3/08

(52) U.S. Cl. CPC G06N 3/08

(57) ABSTRACT

Systems and methods of deep learning-based multi-objective pacing content deployment are disclosed. A first set of input parameters is received and a first set of pacing parameters are generated by a trained pacing model that receives the first set of input parameters. The trained pacing model includes a k-nearest neighbor (KNN) portion and Neural Basis Expansion Analysis for Time Series (N-BEATS) portion. In response to generating the first set of pacing parameters, a pacing pipeline is modified to incorporate the set of pacing parameters. The pacing pipeline is configured to generate deployment parameters. Content is deployed to one or more content systems based on the deployment parameters and feedback data representative of the deployed content is received. A second set of pacing parameters is generated by the trained pacing model. The trained pacing model receives a second set of input parameters that are based at least in part on the feedback data.

### TECHNICAL FIELD

This application relates generally to content deployment systems, and more particularly, to content deployment systems having constrain metrics.

### BACKGROUND

Deployment of electronic content or content elements within network environments can be paced to provide timed deployment of content to satisfy one or more deployment objectives, such as meeting traffic metrics, interaction metrics, and/or other content metrics. In some instances, deployment of content can be constrained by limiting factors, such as limited resources, cost limitations, etc. Current systems generate a fixed deployment plan without consideration of changes that can occur during the deployment period.

In some instances, the available resources for deployment of content can be limited by external factors. For example, where content is being deployed to third party, or external, deployment systems, deployment of content by other entities can impact the available internal and external resources for deploying the remaining content within a deployment plan. Current management systems are not capable of responding to real-time or unexpected changes in deployment factors.

### SUMMARY

In various embodiments, a system is disclosed. The system includes a non-transitory memory and a processor communicatively coupled to the non-transitory memory. The processor is configured to read a set of instructions to receive a first set of input parameters and generate a first set of pacing parameters. The first set of pacing parameters are generated by a trained pacing model that receives the first set of input parameters. The trained pacing model includes a k-nearest neighbor (KNN) portion and Neural Basis Expansion Analysis for Time Series (N-BEATS) portion. The processor is further configured to, in response to generating the first set of pacing parameters, modify a pacing pipeline to incorporate the set of pacing parameters. The pacing pipeline is configured to generate deployment parameters. The processor is further configured to deploy content to one or more content systems based on the deployment parameters, receive feedback data representative of the deployed content, and generate a second set of pacing parameters. The second set of pacing parameters is generated by the trained pacing model. The trained pacing model receives a second set of input parameters. The second set of input parameters are based at least in part on the feedback data.

In various embodiments, a computer-implemented method is disclosed. The computer-implemented method includes steps of receiving a first set of input parameters and generating a first set of pacing parameters. The first set of pacing parameters are generated by a trained pacing model that receives the first set of input parameters. The trained pacing model includes a k-nearest neighbor (KNN) portion and Neural Basis Expansion Analysis for Time Series (N-BEATS) portion. The computer-implemented method includes a step of, in response to generating the first set of pacing parameters, modifying a pacing pipeline to incorporate the set of pacing parameters. The pacing pipeline is configured to generate deployment parameters. The computer-implemented method further includes steps of deploying content to one or more content systems based on the deployment parameters, receiving feedback data representative of the deployed content, and generating a second set of pacing parameters. The second set of pacing parameters is generated by the trained pacing model. The trained pacing model receives a second set of input parameters. The second set of input parameters are based at least in part on the feedback data.

In various embodiments, a non-transitory computer-readable medium having instructions stored thereon is disclosed. The instructions, when executed by a processor, cause a device to perform operations including receiving a first set of input parameters and generating a first set of pacing parameters. The first set of pacing parameters are generated by a trained pacing model that receives the first set of input parameters. The trained pacing model includes a k-nearest neighbor (KNN) portion and Neural Basis Expansion Analysis for Time Series (N-BEATS) portion. The instructions further cause the device, in response to generating the first set of pacing parameters, to perform operations including modifying a pacing pipeline to incorporate the set of pacing parameters. The pacing pipeline is configured to generate deployment parameters. The instructions further cause the device to perform operations including deploying content to one or more content systems based on the deployment parameters, receiving feedback data representative of the deployed content, and generating a second set of pacing parameters, wherein the second set of pacing parameters is generated by the trained pacing model, wherein the trained pacing model receives a second set of input parameters, and wherein the second set of input parameters are based at least in part on the feedback data.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide paced deployment of content using a pacing model, in accordance with some embodiments.

FIG. 3 illustrates an artificial neural network, in accordance with some embodiments.

FIG. 4 illustrates a tree-based neural network, in accordance with some embodiments.

FIG. 5 illustrates a deep learning neural network, in accordance with some embodiments.

FIG. 6 is a flowchart illustrating a method of deploying content using a pacing model, in accordance with some embodiments.

FIG. 7 is a process flow illustrating various steps of the method of deploying content using a pacing model, in accordance with some embodiments.

FIG. 8 is a process flow illustrating a feedback environment for daily deployment of content using a plurality of pacing models, in accordance with some embodiments.

FIG. 9 is a graph illustrating an actual deployment cost over time and a predicted deployment cost over time for a pacing model, in accordance with some embodiments.

FIG. 10 is a flowchart illustrating a method of generating a trained machine learning model, in accordance with some embodiments.

FIG. 11 is a process flow illustrating various steps of the method of generating a trained machine learning model, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for automatically deploying content using a pacing model. In various embodiments, a set of deployment parameters are provided to a pacing engine. The pacing engine includes a pacing model configured to generate a set of pacing factors for determining a rate and/or cost for deployment of content. The pacing factors are provided to a pacing pipeline for generation and deployment of content to internal and/or external deployment systems. In some embodiments, the content is provided to a deployment management system that sets external cost values for deployment of content to external deployment systems. Feedback is received from the initial deployment and updated deployment parameters and an updated pacing model are generated. The updated deployment parameters and updated pacing model are each utilized to generate a new set of pacing factors, which are used to update a deployment process executed by the deployment management system.

In some embodiments, systems, and methods for automatically deploying content using a pacing model includes a trained pacing model configured to receive a set of deployment parameters, generate an estimated total return on investment for based on the deployment parameters, and generate pacing factors for controlling deployment of predetermined content based on the estimated total return on investment. In some embodiments, the pacing model includes a trained combined k-nearest neighbor (KNN) and Neural Basis Expansion Analysis for Time Series (N-BEATS) model. For example, in some embodiments, a trained pacing model is configured to output one or more pacing factors based on a weighted combination of an output of the KNN model and the N-BEATS model.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a neural network which is trained (e.g., configured or adapted) to generate pacing factors, is disclosed. A neural network trained to generate pacing factor may be referred to as a trained pacing model. The trained pacing model can be configured to receive a set of deployment parameters identifying constraints and/or goals of the content deployment, and generate pacing factors to optimize the provided deployment parameters. Deployment parameters can include, but are not limited to, a budget parameter (e.g., a parameter identifying a portion of a limited resource available for the content deployment), a total return on investment parameter, a pacing goal parameter, etc.

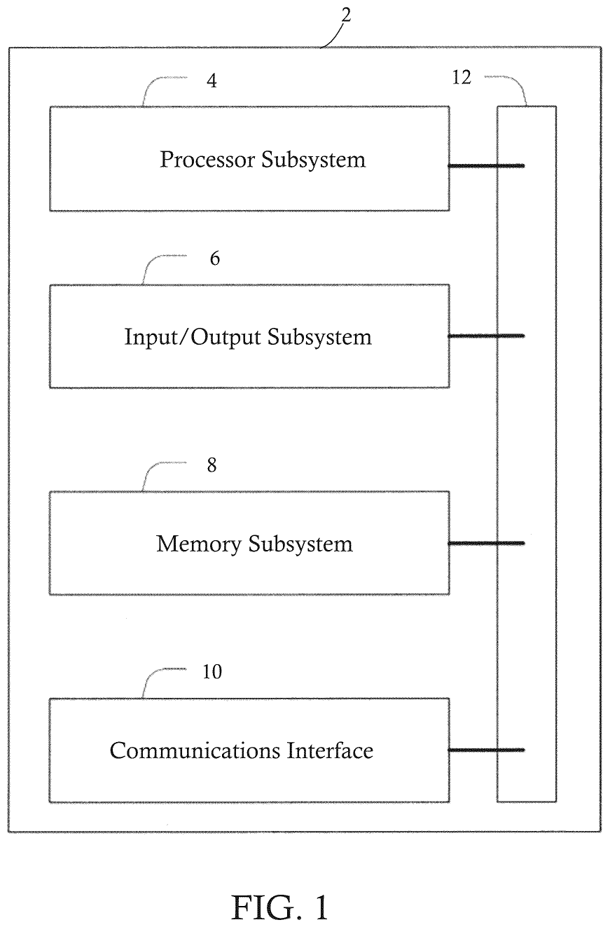

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for generating pacing factors using a trained pacing model, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

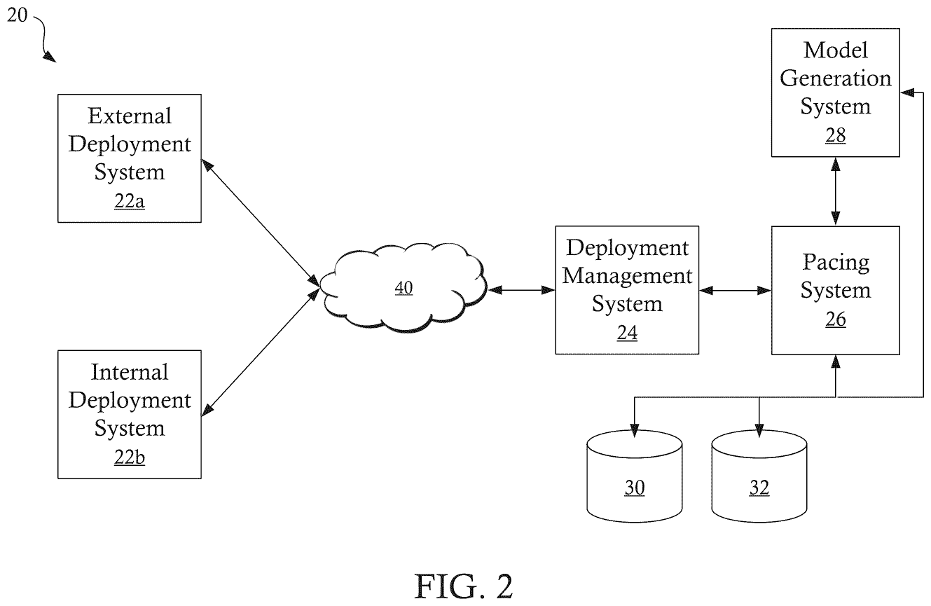

FIG. 2 illustrates a network environment 20 configured to provide automatic deployment of content using pacing factors generated by a pacing model, in accordance with some embodiments. The network environment 20 includes a plurality of systems configured to communicate over one or more network channels, illustrated as network cloud 40. For example, in various embodiments, the network environment 20 can include, but is not limited to, one or more external deployment systems 22a, one or more internal deployment systems 22b, a deployment management system 24, a pacing system 26, a model generation system 28, a historical database 30, and a model store database 32. It will be appreciated that any of the illustrated systems can include a system as described above in conjunction with FIG. 1. Although specific embodiments are discussed, herein it will be appreciated that additional systems, servers, storage mechanism, etc. can be included within the network environment 20.

Further, although embodiments are illustrated herein having individual, discrete systems, it will be appreciated that, in some embodiments, one or more systems can be combined into a single logical and/or physical system. For example, in various embodiments, the deployment management system 24, the pacing system 26, the model generation system 28, the historical database 30, and the model store database 32 can be combined into a single logical and/or physical system. Similarly, although embodiments are illustrated having a single instance of each system, it will be appreciated that additional instances of a system can be implemented within the network environment 20. In some embodiments, two or more systems can be operated on shared hardware in which each system operates as a separate, discrete system utilizing the shared hardware, for example, according to one or more virtualization schemes.

In some embodiments, the deployment management system 24 is configured to deploy content to one or more deployment systems, such as an external deployment system 22a and/or an internal deployment system 22b. Deployment of content to a deployment system 22a, 22b can include an associated cost. The cost can include a fixed cost and/or a variable cost. In some embodiments, the cost of deployment is variable and is determined on an as-deployed basis by the deployment system 22a, 22b. For example, in some embodiments, the deployment management system 24 has a total resource pool available for a predetermined time period. For each deployment of content, the deployment management system 24 expends a portion of the total resource pool. The portion of the total resource pool expended can be determined by a deployment system, for example, on a bidding basis, a surge pricing basis, etc. The deployment management system 24 can be configured to optimize deployment of content, for example optimizing a deployment parameter such as return on investment, over the predetermined time period and given the total resource pool available.

In some embodiments, the deployment management system 24 is configured to provide automatic deployment of content based on pacing factors received from a pacing system 26. The pacing factors are configured to adjust a deployment mechanism, such as a pacing pipeline, configured to deploy content to the deployment systems 22a, 22b. The pacing factors can include, for example, total spend values for a selected period of time, number of content elements to be deployed within a selected time period, estimated performance of deployed content, historical performance of deployed content, target return on investment, and/or other pacing goals.

In some embodiments, the pacing factors are generated by a pacing model implemented by the pacing system 26. The pacing model can include a trained machine learning model configured to receive a set of deployment parameters identifying one or more deployment constraints or targets. For example, in some embodiments, the deployment parameters include, but are not limited to, a cost budget, a target or expected total return on investment, predetermined pacing goals, etc. The deployment parameters are provided to the pacing model, which generates a set of pacing factors that are provided to a pacing pipeline and/or deployment system to determine or control deployment of content. In some embodiments, deployment pacing, as determined by a pacing pipeline, is adjusted by the pacing factors.

In some embodiments, a pacing model is generated by a model generation system 28. The model generation system 28 is configured to generate one or more trained models using, for example, iterative training processes. For example, in some embodiments, a model training engine is configured to receive feedback data and generate one or more trained pacing models. The feedback data can be stored, for example, in historical database 30.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

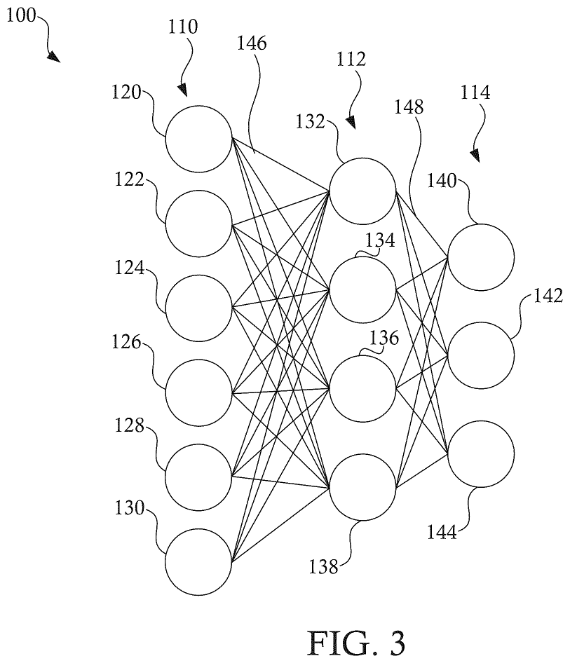

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

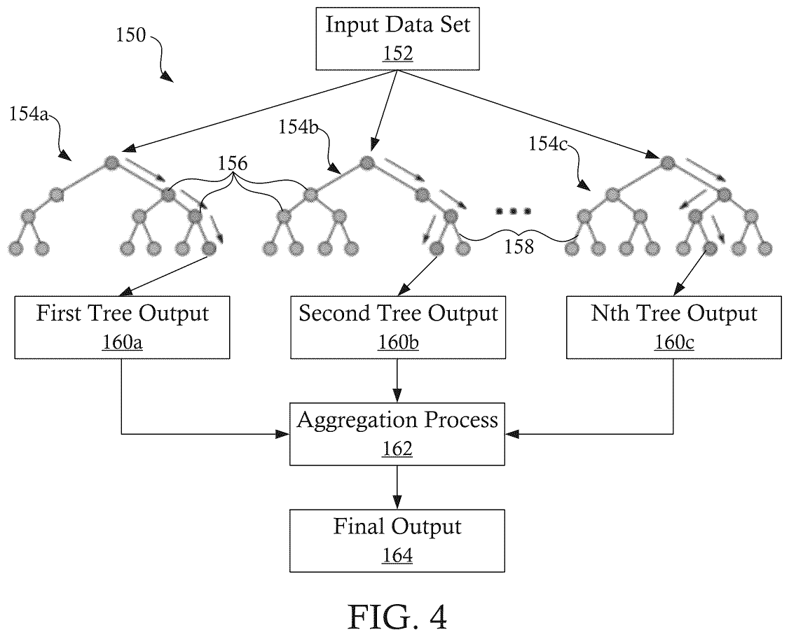

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

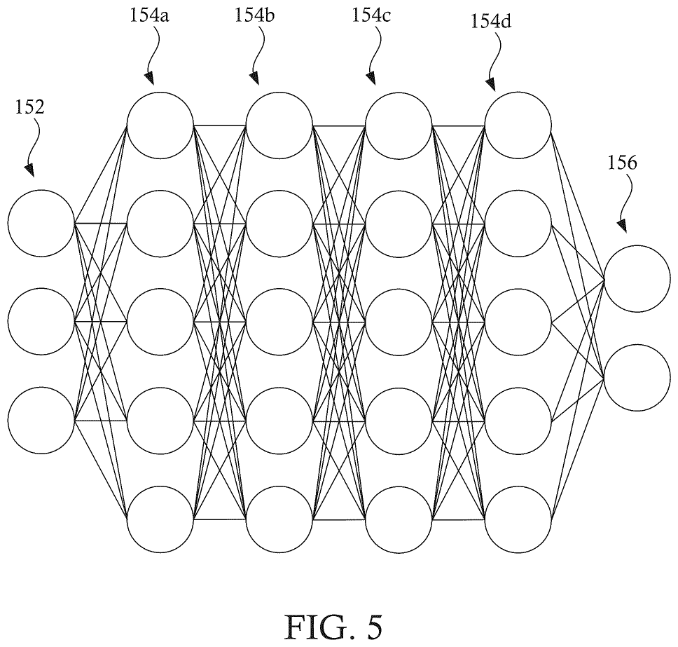

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) can include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 can include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

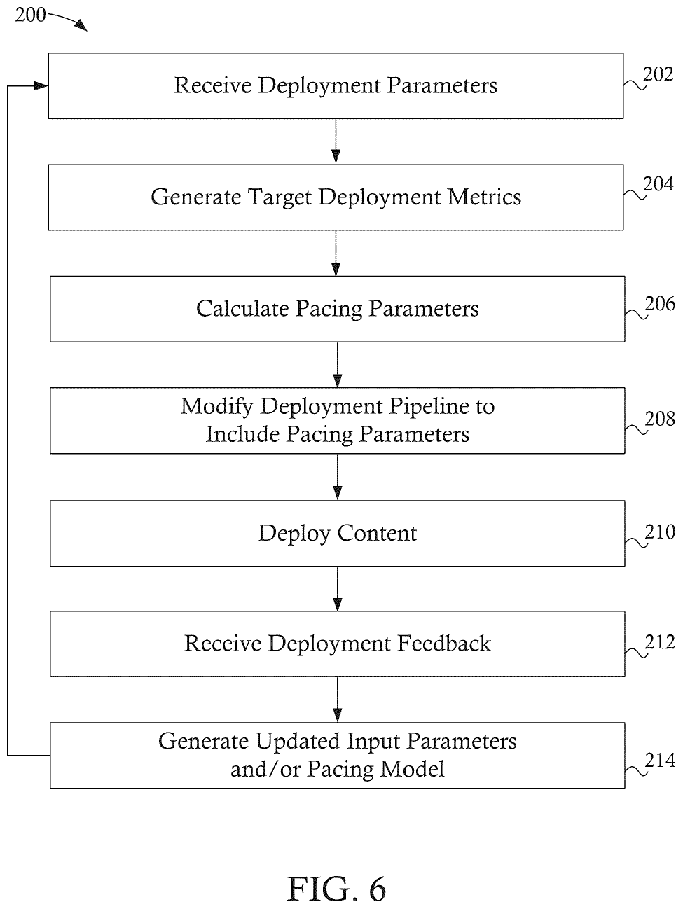

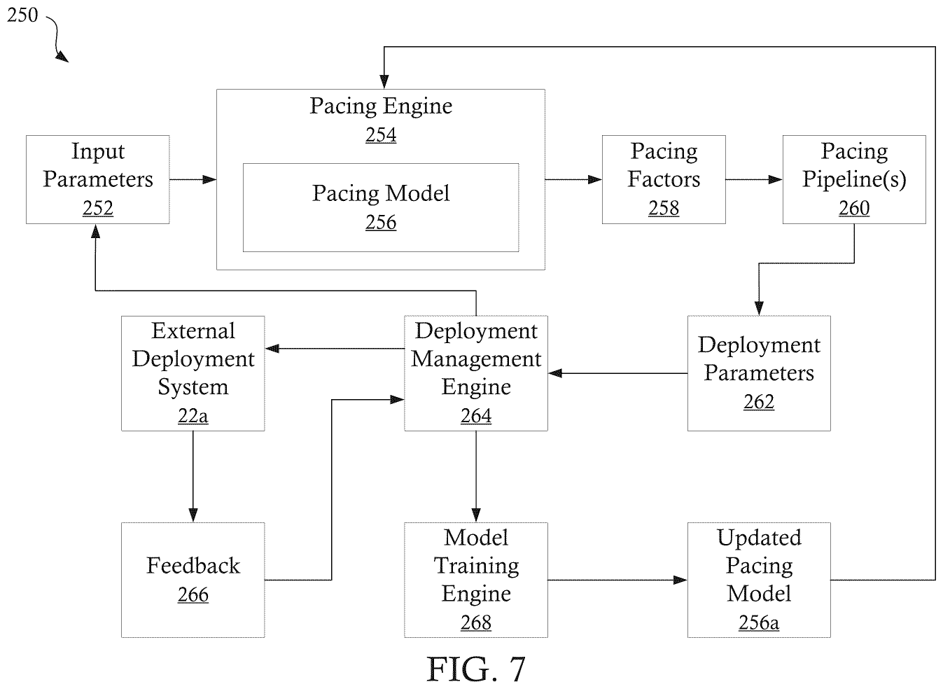

FIG. 6 is a flowchart illustrating a method 200 of deploying content using a pacing model, in accordance with some embodiments. FIG. 7 is a process flow 250 illustrating various steps of the method of deploying content using a pacing model, in accordance with some embodiments. At step 202, a set of input parameters 252 is received. The input parameters 252 can be received from any suitable source, such as, for example, user input via one or more systems, such as a deployment management system, automatically generated input parameters 252 such as input parameters 252 generated based on historical deployment data, and/or any other suitable source. The input parameters 252 can include, but are not limited to, a budget parameter, a total return on investment parameter, a pacing goal parameter, performance data for previously deployed content, etc.

In some embodiments, a budget parameter identifies a total amount of a limited resource consumed to deploy content. For example, deployment of content can include an associated cost. Costs can include, but are not limited to, slot cost, processor or resource time, monetary cost, internally defined resources, etc. The budget parameters provides a total amount of the limited cost that is available for use to deploy content. In some embodiments, the budget parameter defines a budget for a predetermined time period, such as, for example, 1 day, 1 hour, 2 hours, etc. It will be appreciated that a budget parameter can be provided for any suitable predetermined time period.

In some embodiments, a total return on investment parameter identifies an expected or target return on investment for deployment of content over the predetermined time period. For example, a return can be defined in terms of a first metric, such as a predetermined interface action (e.g., click rate, view rate, add-to-cart rate, etc.), a predetermined outcome within a set time period (e.g., monetary spend within a set time period after deployment of an add), and/or any other suitable return metric. The estimated or expected return on investment parameter can represent target metric value in response to deployment of content over the predetermined time period.

In some embodiments, a pacing goal parameter identifies a rate over time for spending a portion of the budget. The pacing goal is configured to determine a balance between achieving a target return on investment and compliance with a budget parameter. For example, the pacing goal can identify a target rate of spend for a limited resource associated with the budget over a sub-portion of the predetermined time period and/or to provide a portion of the targeted return on investment. For example, the pacing goal can identify a spend rate of 10% of the total budget for a first and second time period and 5% of the total budget for a third and fourth time period. Similarly, in some embodiments, the pacing goal can identify a cap on the portion of a budget that can be spent to obtain a portion of the total return on investment. Although specific embodiments are discussed herein, it will be appreciated that any suitable pacing goal can be defined for any portion of the predetermined time period.

In some embodiments, the input parameters 252 include historical performance data for previously deployed content, such as content deployed during one or more prior predetermined time periods. The historical performance data can be obtained as feedback data, as discussed in greater detail below. In some embodiments, a workflow monitoring process is configured to monitor outcomes associated with previously deployed content and generate historical performance data for inclusion in the input parameters 252 and/or for use in training of modified or additional machine learning models, as discussed in greater detail below.

At step 204, a set of pacing factors 258 are determined based on the input parameters 252. The set of pacing factors 258 modify or configure downstream processes. In some embodiments, the input parameters 252 are provided to a pacing engine 254 configured to generate the set of pacing factors 258. The pacing engine 254 can implement one or more pacing models 256. In some embodiments, the pacing model 256 includes a trained machine learning model configured to ingest the input parameters 252, generate a target return on investment for a given time period, and generate a set of pacing factors configured configure a pacing pipeline 260 to generate the calculated target return on investment.

In some embodiments, the pacing model 256 includes a combined machine learning model including two or more trained machine learning frameworks. For example, in some embodiments, the pacing model 256 includes a combined KNN and N-BEATS model. The KNN model includes a non-parametric, supervised learning classifier that is configured to make classifications or predictions about a grouping of individual data points and the N-BEATS model includes a deep neural network model including both backward and forward residual links and a deep stack of fully-connected layers. The N-BEATS model is configured to receive a time-series input and generate a predicted output for a next time period. In some embodiments, the pacing model 256 is configured to generate a weighted combination of an output, e.g., a prediction, of the KNN model and the N-BEATS model.

In some embodiments, the pacing model 256 is a unified target return on investment-based system that is capable of encompassing multiple pacing strategies. The pacing model 256 can be configured to perform various functions based on a selected pacing strategy, as determined by the input parameter 252. Where the input parameters 252 include a budget parameter, the pacing model 256 can be configured to determine pacing rates to meet the budget over the predetermined time period. As another example, where the input parameters 252 do not include a budget parameter, the pacing model 256 can be configured to determined pacing to meet a target return on investment parameter. In some embodiments, where both a budget parameter and a target return on investment parameter are provided, the pacing model 256 can be configured to generate pacing factors configured to produce a final cost under the budget parameter, subject to the minimum required return on investment, while optimizing performance of the content within the given budget.

In some embodiments, at a least a portion of the pacing model 256 is configured to generate a time series prediction. The pacing model 256 can be configured to receive historical and/or real-time feedback including pacing data, actual or target return on investment, actual or target budgets, etc. and forecast, or predict, one or more parameters over the predetermined time period. For example, in some embodiments, the pacing model 256 is configured to receive historical and real-time time related to prior pacing and deployment of content and estimate a return on investment and/or budget spend for a predetermined time period.

In some embodiments, the pacing model 256 is configured to generate a time series prediction for expected total return on investment. For example, the pacing model 256 can be configured to receive a budget parameter, a return on investment parameter, and a pacing goal parameter. A first portion of a trained pacing model 256, such as a KNN model portion, is configured to predict pacing deviation to generate a first predicted final total return on investment for the remaining time in the predetermined time period. In some embodiments, performance parameters including prior and/or current time period performance metrics can be included, such as, for example, real-time feedback for previously deployed content. A second portion of the trained pacing model 256, such as an N-BEATS model portion, is configured to generate a second predicted final total return on investment. The pacing model 256 is configured to generate a set of pacing factors based on a weighted combination of the first prediction and the second prediction.

For example, in some embodiments, the pacing model 256 is configured to apply a weighted average or weighted combination of a prediction generated by the KNN model (e.g., first prediction) and a prediction generated by an N-BEATS model (e.g., second prediction). The weighting factors are representative of a balance between the first prediction and the second prediction. In some embodiments, the pacing model 256 is configured to generate a set of pacing factors by combining predictions according to:

$${w}_{1} * P r e {d}_{KNN} + {w}_{2} * P r e {d}_{N - BEATS}$$

where w₁ and w₂ are the weighting factors, Pred_{KNN} is the prediction value generated by the KNN model, and Pred_{N-BEATS} is the prediction model generated by the N-BEATS model. In some embodiments, the weighting factors are selected such that w₁+w₂=1.0.

In some embodiments, the weighting factors can be adjusted for each iteration of a pacing model 256 and/or adjusted based on one or more input factors, such as time of day, accuracy of models, etc. For example, in some embodiments, a first model, such as an N-BEATS model, can have a higher accuracy for a first portion of a predetermined time period, such as a first portion of the day. During the first portion of the predetermined time period, the higher accuracy model can have a larger weighting factor. As the accuracy of the models converges or inverts, the weighting factors can be adjusted to reflect the accuracy of each model at a given point in time.

At step 208, one or more pacing pipelines 260 are modified by the pacing factors 258. The pacing pipelines 260 are configured to generate a set of deployment parameters 262 for use by a deployment management system 264 when deploying content both internally and/or externally. In some embodiments, the set of deployment parameters includes, but is not limited to, periodic budget spend values (e.g., amount of the total budget to be spent over divisions of the predetermined time period), content element identifiers (e.g., content elements associated with specific spends or for use in content deployment), and/or any other suitable parameters to enable the deployment management system 264 to deploy content.

In some embodiments, the deployment manage system 264 includes a bid management system (BMS) configured to generate and provide bids to external and/or internal content deployment systems 22a, 22b. The generated bids represent a proposed portion of a budget to be spent on each deployment of content. Deployment of content from multiple sources can be managed by deployment systems 22a, 22b as a bid system where content is provided with a proposed resource spend, e.g., a bid, and the highest bids are selected by the deployment systems 22a, 22b and deployed within the network environments managed by the deployment systems 22a, 22b. The deployment parameters 262 generated by a corresponding pacing pipeline 260 can be configured to generate a set of deployment parameters 262 to configure and control bid generation and bid deployment for a bid management system. For example, the deployment parameters 262 can include, but are not limited to, maximum bid values, minimum bid values, total number of bids possible, etc. Although specific embodiments are discussed herein, it will be appreciated that the deployment management system 264 can include any suitable deployment management system.

At step 210, content is deployed to one or more deployment systems 22a, 22b. The content is deployed by the deployment management system 264 as determined by the deployment parameters 262. In some embodiments, the deployment management system 264 is configured to deploy content to external deployment systems 22a that receive content for deployment from multiple deployment management systems 264 associated with various entities. In embodiments including a bid management system, content is deployed as bids to a third party deployment system 22a configured to receive bids and select content to deploy based on a bidding process. In other embodiments, the deployment management system 264 is configured to deploy content to systems operating under a first to offer model, a resource management model, and/or any other suitable content deployment model.

At step 212, feedback data 266 is received. The feedback data 266 can include both express feedback and implicit feedback. In some embodiments, the feedback data 266 can include direct user interactions with deployed content through the deployment system 22a. Direct user interactions can include, but are not limited to, click-through, add-to-cart, page load, and/or any other active interaction. In some embodiments, the feedback data 266 can include indirect feedback, such as traffic data and/or interaction data related to the deployed content. For example, where the deployed content includes a recommended or promoted item, indirect feedback can include traffic volumes for an interface page related to the recommended item, interaction metrics for the recommended item, and/or other data related to the recommended item but not directly related to the deployed content itself.

In some embodiments, the feedback data 266 includes performance data, such as real-time performance data, for the deployed content. Performance data can include, but is not limited to, deployment rate (e.g., the number of proposed deployments sent to the deployment systems 22a, 22b that were actually deployed), interaction rate with deployed content, conversion rate for deployed content, and/or any other suitable performance data. The feedback data 266 can be generated by a deployment system 22a, 22b and/or an internal metric system, such as a pacing pipeline 260 including one or more workflow monitors configured to monitor deployed content and/or metrics indicative of deployed content. In various embodiments, feedback data 266 can include, but is not limited to, aggregate budget spend for one or more prior portions of a predetermined period, aggregate value generated by the deployed content for one or more prior portions of the predetermined period, a return on investment for the one or more prior portions of the predetermined period, and/or any other suitable feedback data.

At step 214, a set of updated input parameters and/or an updated pacing model 256a can be generated and used for subsequent forecasting and pipeline adjustments. In some embodiments, a set of updated input parameters includes updated and/or new performance data based on performance of previously deployed content, such as content deployed according to the deployment parameters 262. In some embodiments, the updated input parameters are based on feedback data 266 received by the deployment management system 264.

In some embodiments, an updated pacing model 256a is generated based, at least in part, on the feedback data 266. As discussed in greater detail below, in some embodiments, a trained pacing model 256a can be generated using an iterative training process. The prior pacing model 256 can be used as a basis for generating an updated pacing model 256a by adjusting one or more parameters based, at least in part, on the feedback data 266. The updated pacing model 256a can be deployed to a pacing engine 254 for use in subsequent

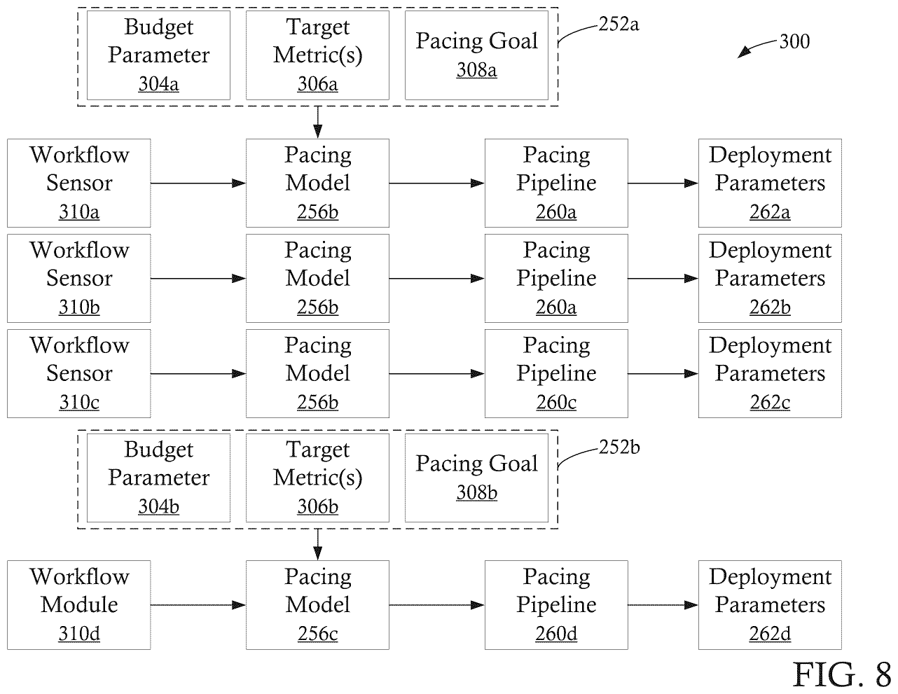

FIG. 8 is a process flow illustrating a deployment environment 300 for periodic deployment of content over a predetermined time period, in accordance with some embodiments. The deployment environment 300 includes a plurality of workflow sensors 310a-310d, each configured to provide performance data to a pacing model 256b-256e. Each of the workflow sensors 310a-310d are configured to provide performance data for a predetermined time period. Each of the workflow sensors 310a-310d can be configured to utilize a similar and/or different portion of a predetermined time period.

For example, in one example, non-limiting embodiment, the predetermined time period is one day. The first workflow sensor 310a can be configured to generate a set of performance data for a first portion of the day corresponding to the first six hours of the day, the second workflow sensor 310b can be configured to generate a set of performance data for a second portion of the day corresponding to the first 8 hours of the day, the third workflow sensor 310c is configured to generate a set of performance data for a third portion of the day corresponding to the first 10 hours of the day, and the fourth workflow sensor 310d is configured to generate a set of performance data for a fourth portion of the day corresponding to the first 20 hours of the day. It will be appreciated that any suitable overlapping and/or non-overlapping portions can be defined for each workflow sensor 310a-310d.

In some embodiments, input data sets 252a, 252b and the generated performance data are provided to a pacing model at predetermined intervals. For example, in the illustrated embodiment, a first input data set 252a is utilized by a pacing model in conjunction with the first set of performance data generated by the first workflow sensor 310a to generate a first set of pacing factors after six hours of content deployment, in conjunction with the second set of performance data generated by the second workflow sensor 310b to generate a second set of pacing factors after eight hours of content deployment, and in conjunction with the third set of performance data generated by the third workflow sensor 310c to generate a third set of pacing factors after ten hours of content deployment. Similarly, a second input data set 252b is used in conjunction with the fourth set of performance data generated by the fourth workflow sensor 310d to generate a fourth set of pacing factors.

In some embodiments, the first input dataset 252a includes a set of input parameters, such as a budget parameter 304a, a target metric parameter 306a, and a pacing goal 308a, corresponding to current day targets and/or parameters and the second input dataset 252b includes a set of input parameters, such as a budget parameter 304b, a target metric parameter 306b, and a pacing goal 308b, corresponding to next day targets and/or parameters. In some embodiments, the second input dataset 252b can be generated based on feedback data received from deployment of content according to pacing factors generated from the first input dataset 252a.

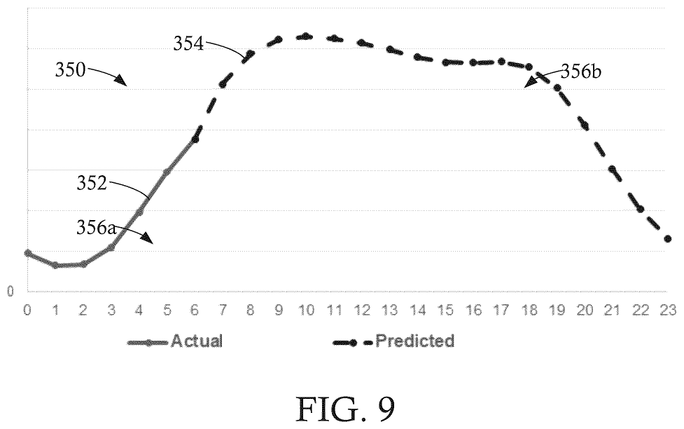

FIG. 9 is a graph 350 illustrating an actual deployment cost over time 352 and a predicted deployment cost over time 354 for a pacing model, in accordance with some embodiments. The estimated deployment cost over time 354 is generated based on a set of pacing factors 258 deployed to a pacing pipeline 260, as discussed in greater detail above. The area under the curve 356a for the actual deployment cost over time 352 represents the budget spend up to the current time period. Similarly, the area under the curve 356b for the predicted deployment cost over time 354 is the estimated budget spend for the entire time period, e.g., over the course of a day.

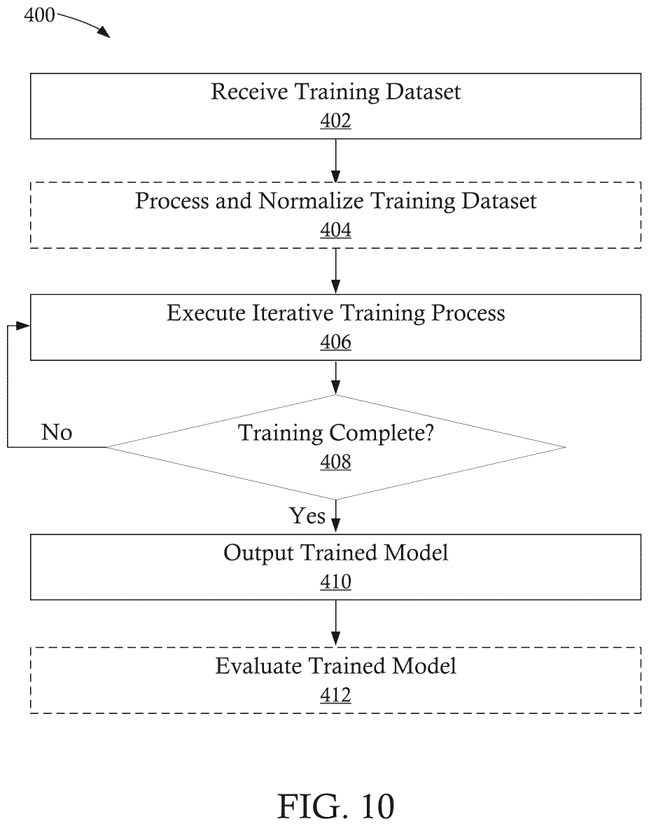

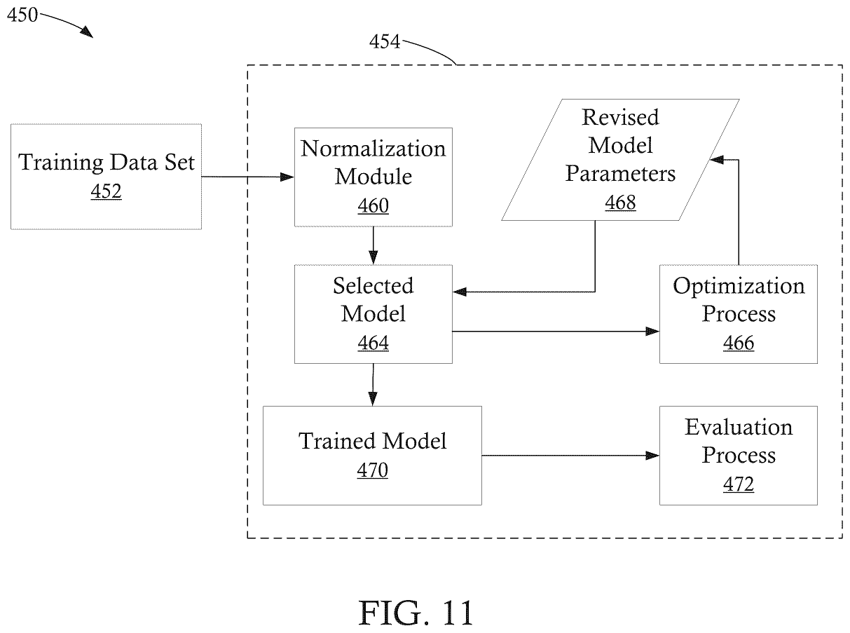

FIG. 10 is a flowchart illustrating a method 400 of generating a trained machine learning model, in accordance with some embodiments. FIG. 11 is a process flow 450 illustrating various steps of the method of generating a trained machine learning model, in accordance with some embodiments. At step 402, a training dataset 452 is received by model training engine 454. The training dataset 452 can include labeled and/or unlabeled data. For example, in various embodiments, a pacing model can be generated using labeled, unlabeled, and/or semi-labelled training data. For example, the training dataset 452 can include budget spend for prior time periods such as total budget spend, budget spend over time, etc., feedback data for the corresponding time periods, e.g., return on investment for the time period, interaction data, pacing factors utilized, etc., and/or other suitable data.

In some embodiments, separate training datasets 452 are utilized to train separate portions of a model. For example, in some embodiments, a first training dataset is provided to train a first model, such as a KNN model, and a second training dataset is provided to train a second model, such as an N-BEATS model. It will be appreciated that the training datasets 452 can be model specific and/or can be filtered to provide related data to each model framework during training. In some embodiments, the output a first model can be used as an input to a second model training process.

In some embodiments, the training datasets 452 include weights and/or combined predictions configured to provide training of a weighting portion during iterative training. For example, in some embodiments, a model is trained to generate a combined prediction based on the output of a first portion such as a KNN model, and a second portion, such as an N-BEATS model. In addition to providing training data for each of the individual models, the training dataset 452 can include combined labeled data configured to provide training of a weighting or combination portion of a trained pacing model.

At optional step 404, the received training dataset 452 is processed and/or normalized by a normalization module 460. In some embodiments, processing of the received training dataset 452 includes outlier detection configured to remove data likely to skew training of a pacing model, such as data from outlier days, data having unusual spend patterns, etc.

At step 406, an iterative training process is executed to train a selected model 464. For example, a model training engine 454 can be configured to obtain a selected model 464 including an untrained (e.g., base) machine learning model, such as an untrained KNN framework, an untrained N-BEATS framework, and/or a partially or previously trained model (e.g., a prior version of a trained model, a partially trained model from a prior iteration of a training process, etc.), from a model store, such as a model store database 32. The model training engine 454 is configured to iteratively adjust parameters (e.g., hyperparameters) of the selected model 464 to minimize a cost value (e.g., an output of a cost function) for the selected model 464. In some embodiments, the cost value is related to a difference between the input data and actual feedback data, e.g., actual budget spend and results.

In some embodiments, the model training engine 454 implements an iterative training process that generates a set of revised model parameters 468 during each iteration. The set of revised model parameters 468 can be generated by applying an optimization process 466 to the cost function of the selected model 464. The optimization process 466 can be configured to reduce the cost value (e.g., reduce the output of the cost function) at each step by adjusting one or more parameters during each iteration of the training process.

After each iteration of the training process, at step 408, the model training engine 454 determines whether the training process is complete. The determination at step 408 can be based on any suitable parameters. For example, in some embodiments, a training process can complete after a predetermined number of iterations. As another example, in some embodiments, a training process can complete when it is determined that the cost function of the selected model 464 has reached a minimum, such as a local minimum and/or a global minimum.

At step 410, a trained contextual explore/exploit model 470, such as a trained contextual bandit model, is generated and, at optional step 412, the trained model 470 can be evaluated by an evaluation process 472. The trained model 470 can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained semantic mapping model.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
receive a first set of input parameters;
generate a first set of pacing parameters, wherein the first set of pacing parameters are generated by a trained pacing model, wherein the trained pacing model receives the first set of input parameters, wherein the trained pacing model includes a k-nearest neighbor (KNN) portion and Neural Basis Expansion Analysis for Time Series (N-BEATS) portion;
in response to generating the first set of pacing parameters, modify a pacing pipeline to incorporate the set of pacing parameters, wherein the pacing pipeline is configured to generate deployment parameters;
deploy content to one or more content systems based on the deployment parameters;
receive feedback data representative of the deployed content; and
generate a second set of pacing parameters, wherein the second set of pacing parameters is generated by the trained pacing model, wherein the trained pacing model receives a second set of input parameters, and wherein the second set of input parameters are based at least in part on the feedback data.

2. The system of claim 1, wherein the first set of input parameters includes a budget parameter, a total return on investment parameter, and a pacing goal parameter.

3. The system of claim 1, wherein the second set of input parameters includes a budget parameter, a total return on investment parameter, a pacing goal parameter, and performance data for the deployed content.

4. The system of claim 1, wherein the content is deployed by a deployment management system.

5. The system of claim 4, wherein the deployment management system is a bid management system.

6. The system of claim 1, wherein the pacing model is configured to generate a time series prediction for expected total return on investment.

7. The system of claim 1, wherein the first set of pacing parameters are generated for a first portion of a predetermined time period, and wherein the second set of pacing parameters are generated for a second portion of the predetermined time period.

8. The system of claim 1, wherein the pacing model is configured to generate a first set of pacing parameters based on a weighted combination of an output of the KNN portion and an output of the N-BEATS portion.

9. A computer-implemented method, comprising:
receiving a first set of input parameters;
generating a first set of pacing parameters, wherein the first set of pacing parameters are generated by a trained pacing model, wherein the trained pacing model receives the first set of input parameters, wherein the trained pacing model includes a k-nearest neighbor (KNN) portion and Neural Basis Expansion Analysis for Time Series (N-BEATS) portion;
in response to generating the first set of pacing parameters, modifying a pacing pipeline to incorporate the set of pacing parameters, wherein the pacing pipeline is configured to generate deployment parameters;
deploying content to one or more content systems based on the deployment parameters;
receiving feedback data representative of the deployed content; and
generating a second set of pacing parameters, wherein the second set of pacing parameters is generated by the trained pacing model, wherein the trained pacing model receives a second set of input parameters, and wherein the second set of input parameters are based at least in part on the feedback data.

10. The computer-implemented of claim 9, wherein the first set of input parameters includes a budget parameter, a total return on investment parameter, and a pacing goal parameter.

11. The computer-implemented of claim 9, wherein the second set of input parameters includes a budget parameter, a total return on investment parameter, a pacing goal parameter, and performance data for the deployed content.

12. The computer-implemented of claim 9, wherein the content is deployed by a deployment management system.

13. The computer-implemented of claim 9, wherein the pacing model is configured to generate a first set of pacing parameters based on a weighted combination of an output of the KNN portion and an output of the N-BEATS portion.

14. The computer-implemented of claim 9, wherein the pacing model is configured to generate a time series prediction for expected total return on investment.

15. The computer-implemented of claim 9, wherein the first set of pacing parameters are generated for a first portion of a predetermined time period, and wherein the second set of pacing parameters are generated for a second portion of the predetermined time period.

16. A non-transitory computer-readable medium having instructions stored thereon which, when executed by a processor, cause a device to perform operations comprising:
receiving a first set of input parameters;
generating a first set of pacing parameters, wherein the first set of pacing parameters are generated by a trained pacing model, wherein the trained pacing model receives the first set of input parameters, wherein the trained pacing model includes a k-nearest neighbor (KNN) portion and Neural Basis Expansion Analysis for Time Series (N-BEATS) portion, and wherein the pacing model is configured to generate a first set of pacing parameters based on a weighted combination of an output of the KNN portion and an output of the N-BEATS portion;
in response to generating the first set of pacing parameters, modifying a pacing pipeline to incorporate the set of pacing parameters, wherein the pacing pipeline is configured to generate deployment parameters;
deploying content to one or more content systems based on the deployment parameters;
receiving feedback data representative of the deployed content; and
generating a second set of pacing parameters, wherein the second set of pacing parameters is generated by the trained pacing model, wherein the trained pacing model receives a second set of input parameters, and wherein the second set of input parameters are based at least in part on the feedback data.

17. The non-transitory computer-readable medium of claim 16, wherein the first set of input parameters includes a budget parameter, a total return on investment parameter, and a pacing goal parameter.

18. The non-transitory computer-readable medium of claim 16, wherein the second set of input parameters includes a budget parameter, a total return on investment parameter, a pacing goal parameter, and performance data for the deployed content.

19. The non-transitory computer-readable medium of claim 16, wherein the content is deployed by a deployment management system.

20. The non-transitory computer-readable medium of claim 19, wherein the deployment management system is a bid management system.
